(19) United States
(12) Patent Application Publication
(10) Pub. No.: US 2008/0243636 A1
(43) Pub. Date: Oct. 2, 2008

(54) Selective Product Placement Using Image Processing Techniques

(75) Inventor: Gene A. Frantz, Sugarland, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/691,926

(22) Filed: Mar. 27, 2007

(51) Int. Cl. G06F 17/00

(52) U.S. Cl. 705/27

(57) ABSTRACT

Embodiments of the invention to provide methods to provide on demand product placement to web based content. A method of in accordance with an embodiment of includes obtaining agreement between entities for placing a product in content. The products image or region of interest in the content is manipulated such that the product is emphasized; and content provider obtains payment for the content based activity of the content.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

This invention is in the field of entertainment, and is more specifically directed to Internet based product placement service.

There is a new direction in entertainment. The old solution has been TV and movies. Content was created by major companies, it was distributed by major networks and paid for by advertisements. We have seen some change with the advent of cable and satellite companies. But, the bulk of the cost was paid by advertisers. In the past, advertising was in form of commercials which interrupts the main program being broadcast.

Product placement is becoming more and more popular. Propaganda GEM (Los Angeles Calif. and other global locations) provides product placement in films, television and video games. Products and logos are placed in content by appearing in the background. Characters or performers in the content may also wear or handle the product.

Product placement seamlessly integrates the product into a realistic context with the content. According to Propaganda GEM, http://www.propagandagem.com/
“a typical product placement budget is a two-tiered structure comprising a service fee in the form of a retainer and a budget to cover placement expenditures with regards to production. The retainer budget generally starts at $150 000 but will greatly depend on the volume and scope of activity. Generally, placement fees vary according to the importance of the production, the characteristics of the product and the duration and exposure of the placement. The conditions and terms are always negotiated upfront. Instead of cash, compensation for placements can sometimes be made in the form of a product/service barter. A barter contract generally includes a reimbursement clause stating that products supplied to movie productions are reimbursed if the placement does not occur.”

There is a new generation of entertainment. We are seeing things like myspace.com and youtube.com where the content is created by individuals and the distribution is done over the web. The budgets for the content does not allow for agencies such as Propaganda GEM. However, there is a need for the present companies to participate in this new content and to make money from it.

### SUMMARY

It is an object of embodiments of the invention to provide a system and methods to provide on demand product placement to web based content. A method of in accordance with a embodiment of includes obtaining agreement between entities for placing a product in content. The products image or region of interest in the content is manipulated such that the product is emphasized; and content provider obtains payment for the content based activity of the content.

Therefore, the system and method of embodiments of the invention solve the problems identified by prior techniques and provide additional advantages.

### BRIEF DESCRIPTION OF THE SEVERAL VIEWS OF THE DRAWING

FIG. 1 is an electrical diagram, in block form, illustrating a home network configuration according to the preferred embodiment of the invention.

FIG. 2 is an electrical diagram, in block form, of a gateway in the network of FIG. 1, constructed according to the preferred embodiment of the invention.

FIG. 3 is a flow diagram illustrating a method in accordance with an embodiment of the invention.

### DETAILED DESCRIPTION

The invention will be described in connection with its preferred embodiment, because it is contemplated that the invention is especially beneficial when realized in such an implementation. However, it is also contemplated that this invention will be beneficial when used in other applications. Accordingly, it is to be understood that the following description is provided by way of example only, and is not intended to limit the true scope of this invention as claimed.

Entertainment is moving from being passive (films and TV) to being active (myspace, youtube etc). With the movement, multiple aspects are no longer the same. Content creation is accomplished by the users rather than professional studios. Distribution is done through the internet rather than through TV stations (now cable and satellite). Advertisement no longer pays for the creation or distribution. The traditional advertising agency model is not working in the active space. There is a need for new ways to pay for the creation and distribution of the content. Embodiments of the invention provide use of Digital Signal Processing (DSP) technology to change the way we advertise in this new media.

Users of the new media do not like obnoxious commercials or “pop up” ads that must be watched before content may be seen. A solution is to use product placement so that the watcher cannot skip through the commercials. The issue is making sure that the watcher does, in fact see the product placement without being obnoxious. Embodiments of the invention selectively alter the video so that the watcher's eyes are directed to the placed product elements. This may be done in a couple of ways.

Let's take Coke as exemplar advertiser. If we could get the content providers to place the Coke can in their blog or movie clip we could then use some signal processing concepts to, defocus all of the scene except for the Coke can for short periods of time, brighten the Coke can for short periods of time, or put motion (movement or altered size) on the Coke can for short periods of time.

The purpose in each case would be to draw the watcher's eyes to the Coke can for short periods of time. The product such as the Coke can in the example may be emphasized or everything else in the image or video may be de-emphasized.

The content provider could be paid a fractional amount each time the content is used for advertisement purposes. The product company could be charged by how long and how many times their product was emphasized.

The product may be a physical object used in the content or a virtual object added to the content after the content is created.

The first method is to modify the focus. The image blocks which represent the product are isolated from the whole picture. Then, the non-isolated blocks are low pass filtered to eliminate or soften the edges. The isolated blocks are then added back to the video stream and presented to the watcher. Those blocks are seen with better focus than those which have been low pass filtered. The product can be focus or the scene except for the product may be defocused.

A second method is intensity. The image blocks which represent the product are isolated from the whole picture. The pixels in the non-isolated blocks are right shifted in one or all of their dimensions (R, G, B or Intensity). Note that right shifting is reducing the brightness by 6 dB per bit. The blocks are then reassembled and shown to the watcher. The blocks containing the product should then be brighter than the rest of the picture.

The third way is to use movement. The blocks representing the product would be alternately moved one block left and then right. This would be repeated at a favorable frequency to catch the eye of the watcher. It is obvious that this could happen side to side, top to bottom or in a rotated manor to give the impression of oscillation.

Yet another way is to altered size of the object. The blocks representing the product would have their pixels decimated every n frames. For example the pixels representing the product would vary from n to n/m at a given rate, where m determines the ratio of decimation. Alternatively, blocks which represent the product could be decimated at the block level rather than the pixel level. This would give the appearance of the product shrinking and expanding, whereas the former option would vary the detail of the product rather than the size.

A highlighted image of the product may also be fused with the content itself by using more or differently sensitive sensors for capturing videos The image of the product may have more detail video information than other parts of a video content. The fusing of video imagery is taught in U.S. Pat. No. 5,140,416 to Richard D. Tinker Aug. 18, 1992. Said application assigned to assignee of instant application and is incorporated herein by reference. Tinker provides a system and method for fusing or merging video imagery from multiple sources such that the resultant image has improved information content over any one of the individual video images. The sensors generating the video imagery are typically responsive to different types of spectral content in the scene being scanned, such as visible and infra-red or short and long wavelength infra-red, and the like.

Embodiments of the invention may be implemented by various processors in personal computers capable of viewing video, home entertainment systems and the like.

DaVinci™ technology may provide devices to use the above algorithms. DaVinci is a trademark of Texas Instruments Incorporated. DaVinci™ processors consist of scalable, programmable processors, including Digital Signal Processing (DSP)-based digital media processors, Advanced RISC Machine (ARM) processors and DSP-based systems-on-chips (SoCs), which include accelerators and peripherals.

Specifically, the processor families TMS320DM644x and TMS320DM643x available from Texas Instruments (Dallas, Tex.) and the like may be used. The TMS320DM644x architecture is a highly integrated system-on-chip (SoC) 100 that has absorbed many of the external components required for digital video. SoC has a DSP Subsystem 110 and Advanced RISC Machine (ARM) Subsystem 120, Video Processor Subsystem (VPSS) 131, Switched Central Resources (SCR) 140, and Peripherals 150. The DM644x devices are based on Texas Instruments' TMS320C64x+DSP core 111, an ARM926 processor 121, video accelerators, DACs, and external memory/storage interfaces. The TMS320DM6443 processor for example is tuned for video applications, provides all of the processing components required to decode digital video, including both analog and digital video output with integrated resizer 131 and On-Screen Display (OSD) engines 132. The TMS320DM6446 processor, tuned for video encode and decode applications (CODEC), adds video encoding capabilities through a dedicated video processing front end capable of capturing various digital video formats 133.

The codec may include algorithms used to compress and decompress the video/image and sound data so that such data is easier for the processors to manage. Codecs define the video settings such as frame rate and size and the audio settings such as bits of quality. Codec may also include region-of-interest (ROI) coding in which a selected ROI is coded with more bits than the remainder of the frame.

A number of different video encoding standards have been established for encoding digital video sequences. The Moving Picture Experts Group (MPEG), for example, has developed a number of standards including MPEG-i, MPEG-2 and MPEG-4. Other examples include the International Telecommunication Union (ITU) H.263 standard, and the emerging ITU H.264 standard. These video encoding standards generally support improved transmission efficiency of video sequences by encoding data in a compressed manner. Preferential encoding of a selected portion of the video information has been proposed. To facilitate ROT processing, the disclosure further contemplates techniques for ROT selection, ROT mapping, ROT signaling, ROT tracking, and access authentication of recipient devices to permit remote control of ROI encoding by a sender device. As will be described, different ROT selection techniques applied by a recipient device or sender device may involve selection of pre-defined ROT patterns, verbal or textual ROT description, or ROT drawing by a user. In a recipient device, ROT mapping involves translation of a selected far-end or near-end ROT pattern into an ROT map, which may take the form of a macroblock (MB) map. ROT signaling may involve in-band or out-of-band signaling of far-end ROT information from a recipient device to a sender device.

ROT tracking involves dynamic adjustment of the far-end ROT map generated by the recipient device, or the local near-end ROT generated by the sender itself, in response to ROT motion. Access authentication may involve granting of access rights and levels to recipient devices for purposes of remote far-end ROT control, as well as resolution of ROT control conflicts between recipient and sender devices.

System on a Chip (SoC)/Digital signal processor (DSP) may be operable in Television or home entertainment unit, set-top box or home-link gateway.

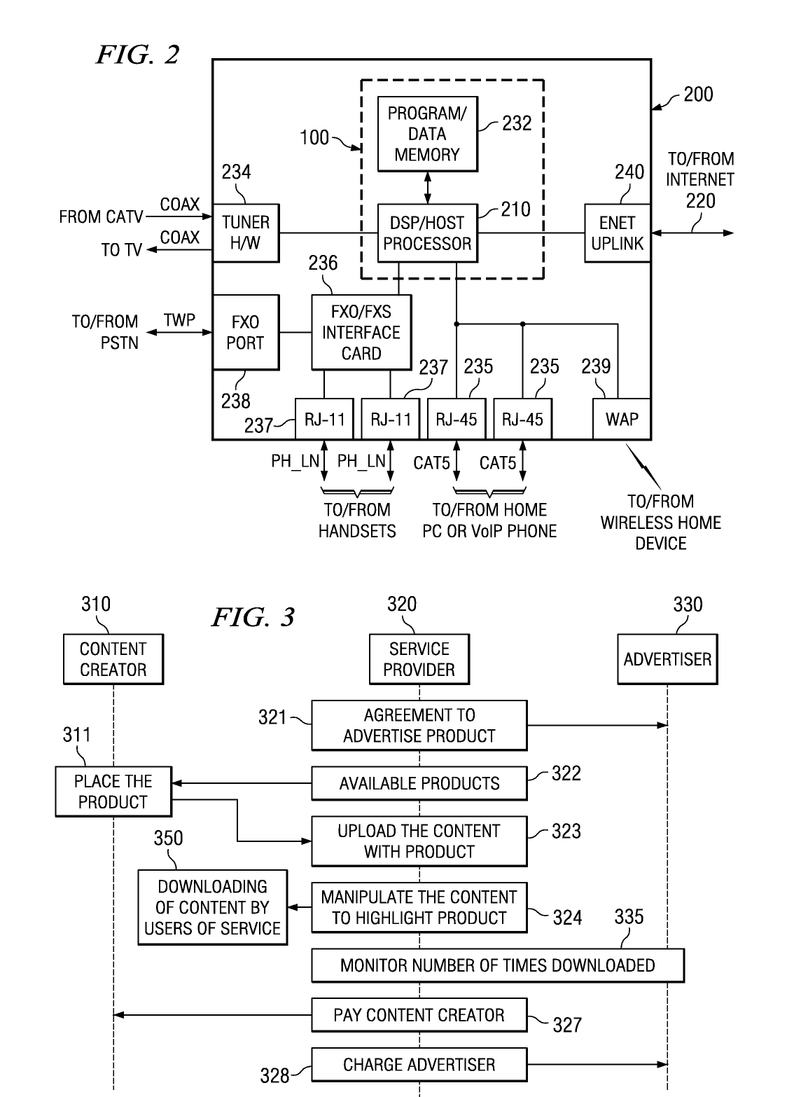

FIG. 2 illustrates an example of the construction of home-link gateway 200, according to the preferred embodiment of the invention. The architecture illustrated in FIG. 2 is presented by way of example only, and is not intended to be exhaustive of the manner in which home-link gateway 200 may be realized. It is contemplated that those skilled in the art having reference to this specification will be readily able to realize the functions of home-link gateway 200 according to variations on this architecture, or indeed by way of alternative architectures.

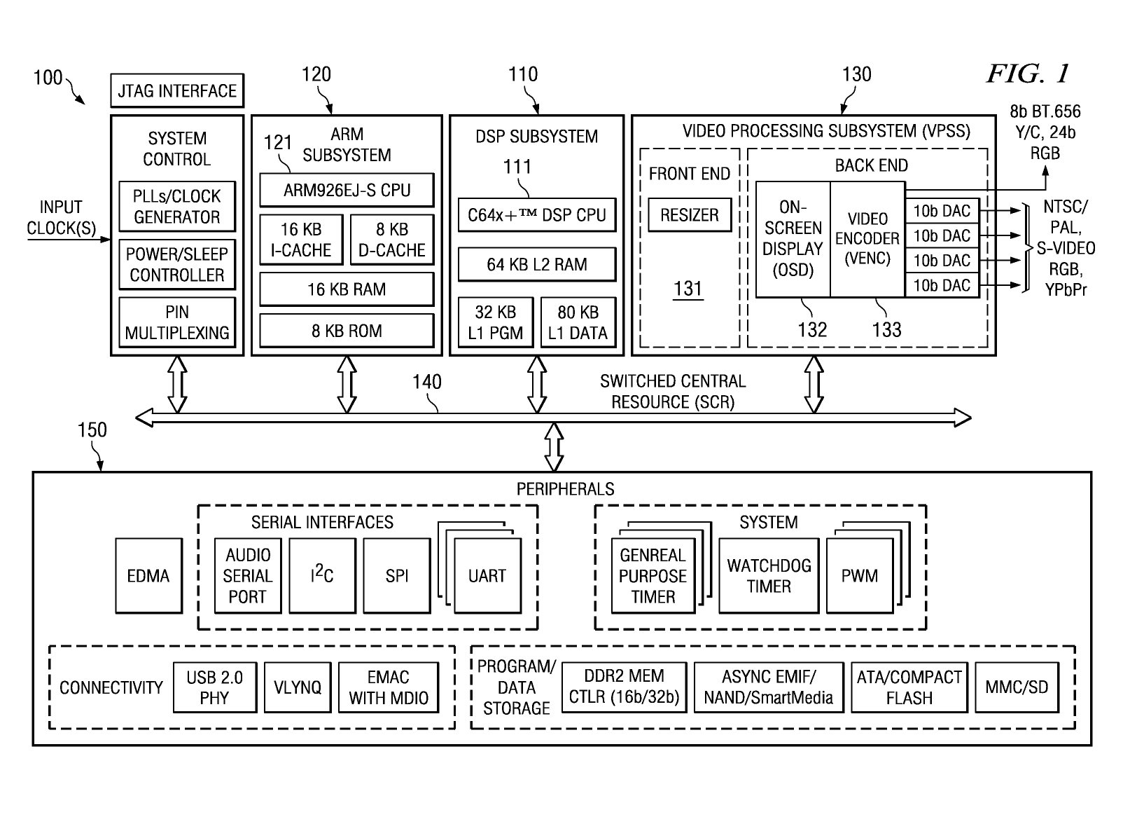

As shown in FIG. 2, home-link gateway is controlled by “System on a Chip” (SoC) 230, which serves as the main system host processor for control of the signaling among the various physical media to which home-link gateway 200 interfaces. As known in the art, a “System on a Chip” (SoC) 230 architectures realize a relatively full digital processing system on a single integrated circuit, and as such typically include a microprocessor or programmable processor core 210, as well as memory 232 and input/output resources (not shown). For example, SoC 230 may be realized as shown in FIG. 1, according to this preferred embodiment of the invention. DSP core 210 in addition may connected to program and data memory 232; the program portion of memory 232 may be realized at least in part by hard disk storage, flash or other non-volatile memory resources, for storing the executable instructions according to which gateway 200 carries out the control functions described in this specification; the data portion of memory 232 may, of course, include both non-volatile and volatile memory for storing the data required and useful in carrying out these functions. Of course, the functions of SoC 230 in this embodiment of the invention may be alternatively realized by multiple integrated circuit devices, if desired.

Gateway 200 includes ports and interface functions as shown in FIG. 2. FXO/FXS interface 236 in home-link gateway 10 provides support and functionality to carry out conventional telephony, and as such is coupled to SoC 230. FXO port 238 is connected to FXO/FXS interface card 236, through which connection is made between home-link gateway 200 and the PSTN, typically by way of RJ-11 hardware and twisted-pair wire media. FXO port 238 is, of course, the interface to the PSTN, and as such FXO port 238 appears, to the PSTN, as a conventional telephone device. On the FXS side, FXO/FXS interface card 236 also connects, via RJ-11 jacks 237 and conventional phone lines PH_LN, to conventional telephone handsets (e.g., handsets 280 in FIG. 1). The FXS ports of FXO/FXS interface card 236 appear, to telephone handsets 280, as the PSTN itself, as known in the art for FXS interface devices and functions. It is contemplated that those skilled in the art can realize FXO/FXS interface card 236 in home-link gateway 200, according to conventional construction for such functionality, without undue experimentation.

Home-link gateway 200 also includes functionality for local area network (LAN) access within home H. As shown in FIG. 2, SoC 230 is bidirectionally coupled to multiple LAN connections, including RJ-45 jacks 235 to which client devices such as the network adapter in a client PC or a VoIP telephone handset can be connected via conventional network cable CAT5. In addition, wireless access point (WAP) functionality 239 is also provided within home-link gateway 200 according to this embodiment of the invention, for wireless LAN communication with client devices within home H.

Other types of local area network arrangements may alternatively or additionally be supported by home-link gateway 200. For example, home-link gateway 200 may support coaxial cable in-home LAN communications, as described in U.S. Pat. No. 6,941,576 B2 and in co-pending U.S. patent application Ser. No. 09/636,019, filed Aug. 10, 2000, both assigned to Texas Instruments Incorporated and incorporated herein by this reference.

It is contemplated that some or all of the functionality of home-link gateway 200 may be integrated into one or more than one integrated circuits. For example, the communications functions of FXO/FXS interface card 236, and those functions involved in LAN communications via RJ-45 jacks 235 and WAP functionality 239, may be realized by portions of conventional systems such as the TNETV1061 residential gateway from Texas Instruments Incorporated.

According to the preferred embodiment of the invention, home-link gateway 200 may include Ethernet uplink function 240, which serves as a high-speed Ethernet port by way of which home-link gateway 200 communicates with the Internet 220. Home-link gateway 200 may include its own modulator/demodulator (“modem”) functionality for formatting communications transmitted to and received from the Internet 220, for example according to broadband techniques known in the art for DSL and cable modem data communications, or alternatively a separate modem (not shown) may be provided externally from home-link gateway 200, and connected between Ethernet uplink 240 and the corresponding physical communications facility (e.g., twisted-pair wire for DSL, coaxial cable for cable modem communications, wireless signals for wireless or satellite communications, etc.).

According to the preferred embodiment of the invention, as will now be described, home-link gateway 200 provides remote access, via the Internet 220 and uplink function 240, to the telephony services that it supports and manages within home H. It is contemplated that this access and management of this access will be carried out by DSP core 210 in SoC 230, through the execution of program instructions stored in memory 232; of course, this functionality may also be realized by custom hardware, as determined by the skilled artisan having reference to this specification. FIG. 3 illustrates, by way of a flow diagram, the carrying out of embodiments of the invention.

FIG. 3 shows three possible entities which may be involved in a method in accordance of an embodiment of the invention. These entities include content creator 310, service provider 320, advertiser 330. The service provider 320 obtains agreement 321 to advertise a product from an advertiser 330 and offer these products 322 to the service users for placement in their content. The content creator 310 may also get a agreement directly from the advertiser 330. The content creator 310 may place the product some content they create 311.

The service provider uploads the content to their server 323. The service provider then manipulates the content so that the product can be emphasized 324. The goal is to make the product standout, so the term emphasized is to make the product stand out relative to other objects and backgrounds in the video. So emphasizing the product relative to other items may include de-ephasizing other items in the image or video relative to the product. The content may then de downloaded by users of the service 350.

Ways to monitor the activities of users such as number of times the content is download 335 may be done by the service provider 320 or the advertiser 330.

The service provider pays the content creator 310 payments based on the activities on the users of the service 327. The advertiser 330 is charged 328 for an amount equal to or greater then the payment provider to the creator 310. The service provider may also charge other fees such as service fees to the advertiser or content creator.

In U.S. Pat. No. 6,904,264 issued Jun. 7, 2005 to Gene A. Frantz—inventor of the instant invention, an entity called a content agent was described. Said patent herein incorporated by reference. In that patent's context, a content agent is an entity that handles the payment for digital content and authorizes the user's downloading of that content. For example, content agent may be the owner of the intellectual property rights in the content, a wholesaler of digital content, a digital content clearinghouse, the digital radio station, or the artist or entity responsible for creating the content. The responsibility for collecting payment, or royalties, for the downloading of a selection of digital content may be distributed among many content agents, each having responsibility and authorization to receive payment for and authorize the downloading of digital content. As an example, the content agents for a particular song or music video may be the radio station, the record company, or a digital content clearinghouse. Any of these content agents can handle the purchase of the right to download the song or music video.

In the instant application the role of the content agent may be but not limited to the service provider such as YouTube, MySpace and the like. The content agent may act as an intermediary between the content provider/user to the product advertiser or owner. An on-line virtual ad agency may also be an example of a content agent to match content with a product for placement. The on-line agency may be a virtual presence of a traditional “bricks and morter” advertising agency.

A method is needed to evaluate the product placement and monitoring response. For old media, Propaganda GEM has developed the PREVA media Entertainment Media Valuation System. The system looks at the difference between the ‘cost’ of a placement and the ‘value’ of the placement. For embodiments of the invention, cost can be more directly related to the value because of the direct interaction with the Point of Content (PoC).

While the present invention has been described according to its preferred embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of placing advertisements on content over the internet, comprising:
obtaining agreement from a service provider to advertise a product of an advertiser;
placing the product in a piece of content;
manipulating the content such that the product is emphasized; and
uploading the content with the placed product; and
receiving payment for the content based on a monitoring of user activities.

2. The method of claim 1, wherein monitoring is counting the number of times the content is downloaded by a user and receiving payment is receiving payment of a set amount of money for each time the content is viewed by a user.

3. The method of claim 1, wherein obtaining agreement comprising:
responding to a general bid to advertise a product;
receiving media object data and instructions for placing the product in the content; and
placing the product in the content comprises rendering media object data into content, wherein the media object data and instructions include attributes to highlight the media in the content.

4. The method of claim 1, wherein manipulating the content such that the product is emphasized includes modify a focus of the product or the rest of the content.

5. The method of claim 1, wherein manipulating the content such that the product is emphasized includes changing an intensity of the product or the rest of the content.

6. The method of claim 1, wherein manipulating the content such that the product is emphasized includes a movement to the product relative to the rest of the content.

7. The method of claim 1, wherein manipulating the content such that the product is emphasized includes altering the size of the product relative to the rest of the content.

8. A method of placing advertisements in content on the internet by a service provider, comprising:
receiving content from a user with agreement to insert media objects representing a product into the content;
obtaining agreement from an advertiser to advertise a product in the content;
rendering media object data into content such that the product is emphasized; and
loading the content with the placed product onto a server provided by the service provider.

9. A method of placing advertisements in content on the internet by a service provider, comprising:
agreeing to advertise a product;
offering a plurality of products to be advertised;
receiving at least one piece of content with at least one product to be advertised from a creator of content;
manipulating the content such that the at least one product is emphasized;
offering the content for downloading by users of the service;
monitoring a number of times the at least one piece of content with at least one product to be advertised;
paying the content creator a set amount of money based on the monitoring; and
charging the advertiser of the product a set amount equal to or greater than the amount paid to the content creator.

10. The method of claim 9, wherein manipulating the content such that the product is emphasized includes modify a focus of the product or the rest of the content.

11. The method of claim 9, wherein manipulating the content such that the product is emphasized includes changing an intensity of the product or the rest of the content.

12. The method of claim 9, wherein manipulating the content such that the product is emphasized includes a movement to the product relative to the rest of the content.

13. The method of claim 9, wherein manipulating the content such that the product is emphasized includes altering the size of the product relative to the rest of the content.
